(19) United States
(12) Patent Application Publication
(10) Pub. No.: US 2009/0174784 A1
(43) Pub. Date: Jul. 9, 2009

(54) CAMERA HAVING DIGITAL GRAY FILTERING AND METHOD OF PROVIDING SAME

(76) Inventors: Sven-Olof KARLSSON, Malmo (SE); Fredrick LONN, Sodra (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/970,558

(22) Filed: Jan. 8, 2008

(51) Int. Cl. H04N 5/228

(52) U.S. Cl. 348/222.1; 348/E05.031

(57) ABSTRACT

A camera includes an image sensor made up of an array of image sensing elements arranged in rows and columns. In addition, the camera includes a lens for imaging a field of view onto the image sensor, and timing circuitry that controls an integration period of each of the image sensing elements, the integration period representing a time during which the image sensing element acquires charge as a function of light incident on the image sensing element. Further, the camera includes gray filter circuitry, operatively coupled to the timing circuitry, for adjusting the integration period of image sensing elements above a horizon defined within the field of view relative to the integration period of image sensing elements below the horizon.

### TECHNICAL FIELD OF THE INVENTION

The present invention relates to cameras, and more particularly to digital cameras using an image sensor.

### DESCRIPTION OF THE RELATED ART

Common landscape photography presents a difficult challenge to most cameras. The ratio in brightness between the sky and ground usually is much greater than the dynamic range of the camera. Oftentimes a resultant picture is either very bright or very dark. For example, FIG. 1 illustrates a case where the camera settings are adjusted based primarily on the brightness of the sky 10. As a result, the land 12 below the horizon 14 tends to be too dark or underexposed. Conversely, FIG. 2 illustrates a case where the camera settings are adjusted based primarily on the brightness of the land 12. The result is that the sky 10 above the horizon 14 is too bright or overexposed. This is true for wet film cameras as well as digital cameras.

Such problem has been addressed in the past by using a neutral density filter that covers only half the field of view. By placing the filter in the area occupied by the sky 10, the scene luminances can be kept within the dynamic range of the camera. However, such neutral density filters present their own set of problems. For example, additional filters can be cumbersome and relatively expensive, particularly in the case of mobile phone cameras and other point-and-shoot type cameras.

Accordingly, there is a strong need in the art for a solution to the aforementioned problem of limited dynamic range of a camera. In particular, there is a need for a solution that avoids being cumbersome and/or expensive.

### SUMMARY

According to an aspect of the invention, a camera includes an image sensor made up of an array of image sensing elements arranged in rows and columns. In addition, the camera includes a lens for imaging a field of view onto the image sensor, and timing circuitry that controls an integration period of each of the image sensing elements, the integration period representing a time during which the image sensing element acquires charge as a function of light incident on the image sensing element. Further, the camera includes gray filter circuitry, operatively coupled to the timing circuitry, for adjusting the integration period of image sensing elements above a horizon defined within the field of view relative to the integration period of image sensing elements below the horizon.

In an embodiment, the integration period of each of the image sensing elements is defined by a period of time between the timing circuitry providing a reset control signal to the image sensing element and providing a read control signal to the image sensing element.

In another embodiment, the horizon is generally defined by a fixed row or set of rows of the image sensing elements.

According to another embodiment, the horizon is generally defined by a row or set of rows of the image sensing elements, the particular row or set of rows being selectable.

According to yet another embodiment, the particular row or set of rows are selectable with a user input.

In still another embodiment, the camera further includes horizon detection circuitry for automatically selecting the particular row or set of rows.

In yet another embodiment, the horizon detection circuitry pre-analyzes relative amounts of light received by the image sensing elements in order to automatically select the particular row or set of rows.

According to another embodiment, the gray filter circuitry adjusts the integration period of the image sensing elements above the horizon so as to be shorter in time relative to the integration period of the image sensing elements below the horizon.

In another embodiment, the integration periods of the image sensing elements above the horizon relative to the integration periods of the image sensing elements below the horizon change gradually.

In still another embodiment, the integration periods change linearly.

With still another embodiment, the integration periods change non-linearly.

According to yet another embodiment, the integration periods of the image sensing elements above the horizon relative to the integration periods of the image sensing elements below the horizon change on a row by row basis.

According to another embodiment, the integration periods of the image sensing elements above the horizon relative to the integration periods of the image sensing elements below the horizon change as a step function.

In another embodiment, the gray filter circuitry is selectively enabled manually by a user input.

According to another embodiment, the gray filter circuitry is selectively enabled automatically.

According to another embodiment, the gray filter circuitry adjusts the integration period of the image sensing elements above the horizon so as to be longer in time relative to the integration period of the image sensing elements below the horizon.

In yet another embodiment, the gray filter circuitry adjusts the relative integration periods using at least one of a look-up table and separate autoexposure loops corresponding to above and below the horizon.

In accordance with another aspect of the invention, a method for performing filtering in a camera is provided. The camera includes an image sensor having an array of image sensing elements arranged in rows and columns; a lens for imaging a field of view onto the image sensor; and timing circuitry that controls an integration period of each of the image sensing elements, the integration period representing a time during which the image sensing element acquires charge as a function of light incident on the image sensing element. The method includes adjusting the integration period of image sensing elements above a horizon defined within the field of view relative to the integration period of image sensing elements below the horizon.

According to an embodiment, the integration period of each of the image sensing elements is defined by a period of time between the timing circuitry providing a reset control signal to the image sensing element and providing a read control signal to the image sensing element.

According to another embodiment, the integration periods are adjusted in order that the adjusted integration periods of the image sensing elements above the horizon change gradually relative to the adjusted integration periods of the image sensing elements below the horizon.

In another embodiment, the integration periods of the image sensing elements above the horizon relative to the integration periods of the image sensing elements below the horizon change are adjusted on a row by row basis.

According to another embodiment, the method includes selectively defining the horizon automatically.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 represents a picture exhibiting underexposure in a lower portion;

FIG. 2 represents a picture exhibiting overexposure in a lower portion;

FIGS. 3 and 4 illustrate a mobile phone incorporating a camera in accordance with an exemplary embodiment of the present invention;

FIG. 5 is a block diagram of the mobile phone of FIGS. 3 and 4 incorporating a camera in accordance with the exemplary embodiment of the present invention;

FIG. 6 is a block diagram of a camera in accordance with the exemplary embodiment of the present invention;

FIG. 7 is a block diagram of an image sensor included within a camera in accordance with the exemplary embodiment of the present invention;

FIG. 8 illustrates a manner in which a horizon may be defined automatically within a camera in accordance with the exemplary embodiment of the present invention;

FIG. 9 illustrates a manner in which a horizon may be defined manually within a camera in accordance with the exemplary embodiment of the present invention;

FIG. 10 represents an integration period of respective rows of image sensing elements within an image sensor according to a conventional camera; and

FIGS. 11-13 illustrate a change in integration period of respective rows of image sensing elements within an image sensor according to corresponding exemplary embodiments of the present invention; and

### DETAILED DESCRIPTION OF EMBODIMENTS

The present invention will now be described with reference to the drawings, wherein like reference labels are used to refer to like elements throughout.

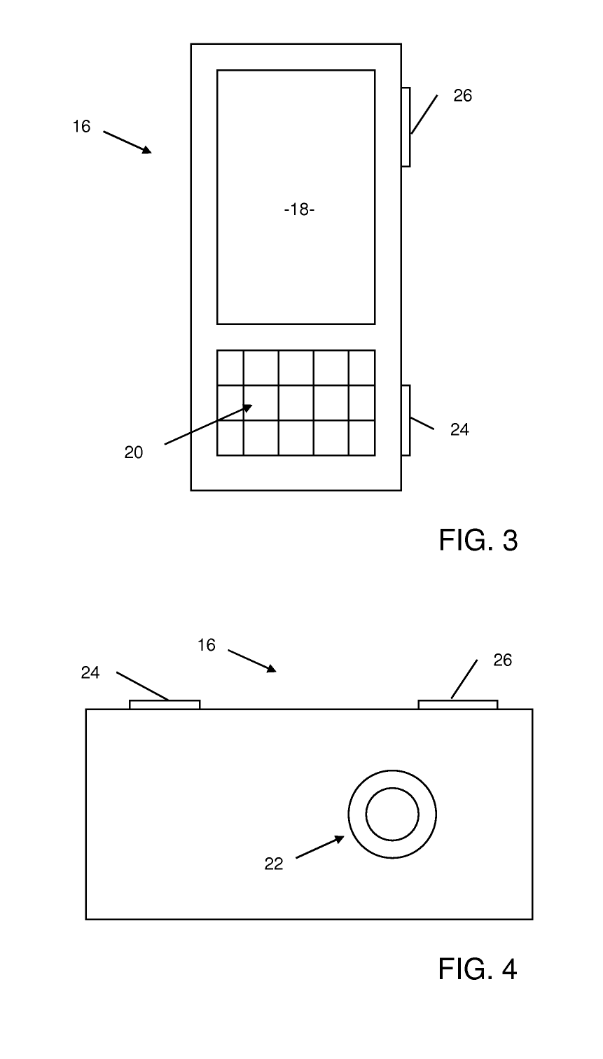

Referring initially to FIGS. 3 and 4, a mobile phone 16 is shown in accordance with an exemplary embodiment of the present invention. The mobile phone 16 includes a camera function that enables the mobile phone 16 to function also as a camera, as has become common nowadays. However, those having ordinary skill in the art will appreciate that the present invention applies to any camera whether it be a standalone camera or a camera incorporated in some other type of device such as a phone, etc.

In accordance with the present invention, the camera avoids the above-described problems associated with landscape photography. More particularly, the camera includes an image sensor and a lens for imaging a field of view onto the image sensor. The image sensor is made up of an array of image sensing elements, each of which acquire charge based on the amount of light incident thereon when taking a picture. The image sensing elements acquire charge during an integration period associated with the taking of the picture. As is explained in more detail below, the camera includes gray filter circuitry that compensates for limitations in the dynamic range of the camera, specifically in the case of landscape photography, by adjusting the integration period of the respective image sensing elements. In the exemplary embodiment, the gray filter circuitry adjusts the integration periods such that the integration periods of the image sensing elements above the horizon 14 are shorter than the integration periods of the image sensing elements below the horizon 14.

Consequently, the difference in resultant signal levels due to the sky 10 and the land 12 is reduced and the outputs of the respective image sensing elements will tend to remain within the dynamic range of the camera. Thus, the camera produces higher quality pictures and avoids producing pictures that are too bright or too dark.

As also explained in more detail below, the location of the horizon 14 within the field of view may be fixed or adjustable. In one embodiment, the location of the horizon 14 is fixed at a predefined location within the field of view, such as along a horizontal line approximately midway between the top and bottom of the field of view. In another embodiment, the camera includes a horizon detection circuit that automatically detects the horizon 14 by analyzing variations in the intensity of light detected by the image sensing elements prior to taking the picture. According to another embodiment, the user may manually identify the horizon 14 within the field of view.

The gray filter circuitry preferably transitions the integration periods of the image sensing elements gradually across the horizon 14. By providing a gradual transition, the change in the resultant picture due to filtering is less perceptible to the human eye. Nevertheless, the transition may be more abrupt without departing from the scope of the invention.

Continuing to refer to FIGS. 3 and 4, the mobile phone 16 includes a display 18 and keypad 20 as is conventional. The display 18 may display a variety of information useful in the operation of the mobile phone 16 including, for example, menus, contact information, and various other types of information, media, etc. As is also conventional, during operation as a camera the display 18 may serve as a viewfinder. The keypad 20, and in the case of a touch sensitive display 18, enables a user to input data, menu selections, function commands, etc.

The camera portion of the mobile phone 16 includes a camera lens 22. Thru the camera lens 22, a user may take photographs. Additionally, the mobile phone 16 may include one or more discrete buttons 24, 26 for operating the phone 16. For example, button 24 may serve as a shutter and button 26 may provide zoom control during camera operation. Moreover, the buttons may have other functions associated therewith (e.g., volume control, menu selection, etc.) when the mobile phone 16 carries out other types of operation (e.g., as a phone, media player, personal planner, etc.).

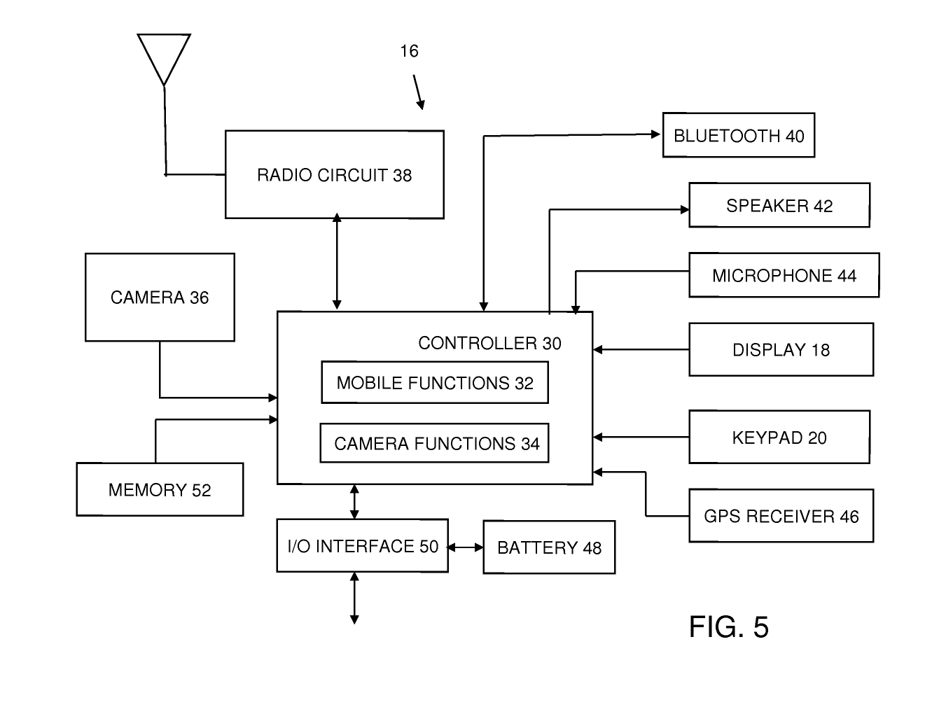

FIG. 5 is a simplified block diagram of the mobile phone 16. The phone 16 includes a controller 30 programmed to provide overall control of the phone in relation to the various operations described herein. For example, the controller 30 is programmed to provide conventional mobile phone functions 32 as well as camera functions 34 as described herein. One having ordinary skill in the art of programming will appreciate different manners in which the controller 30 may be programmed to provide the operation described herein. The particular programming is not germane to the present invention, and therefore has been omitted for sake of brevity.

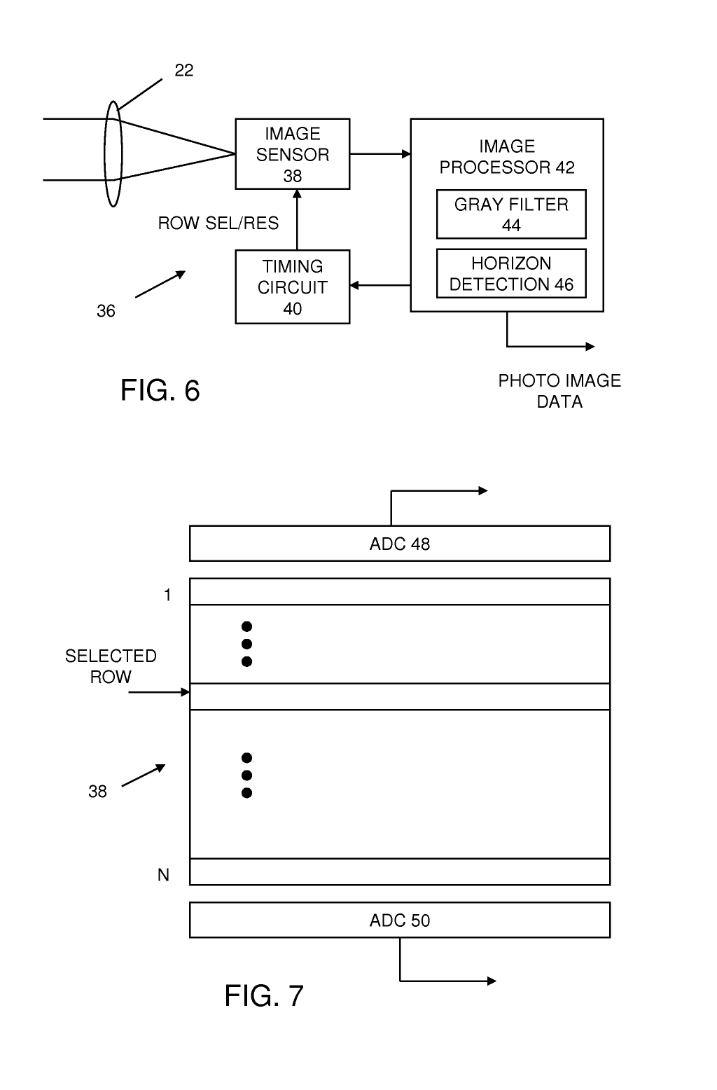

As will be described in more detail below in relation to FIGS. 6-13, the mobile phone 16 includes a camera 36 incorporating the features of the present invention. In addition, the mobile phone 16 includes a radio circuit 38 and wireless interface 40 (e.g., Bluetooth), for example, that enable the mobile phone 16 to carry out conventional wireless communications over a mobile phone network, wireless local area network (WLAN), etc. The mobile phone 16 further includes a speaker 42 and microphone 44 for enabling phone communications, audio reproduction and recording, etc. Moreover, the mobile phone 16 includes the aforementioned display 18 and keypad 20 (including any other keys or buttons 24, 26, etc.). A GPS receiver 46 is provided for acquiring location information as has become common in mobile phones. A battery 48 provides operating power to the mobile phone 16, and an I/O interface 50 enables data and/or power transfer between the phone 16 and an external device (not shown). Finally, the mobile phone 16 includes memory 52 for storing programming code, data, etc., as is conventional.

Turning now to FIG. 6, a camera 36 in accordance with an exemplary embodiment of the present invention is shown. The camera 36 includes the aforementioned lens 22. The lens 22 is represented by a single lens element, although it will be appreciated that the lens 22 may represent an arrangement of lenses as is conventional in a camera. Further, the lens 22 may include, for example, a zoom lens arrangement. The lens 22 has a field of view which the lens 22 images onto an image sensor 38 included in the camera 36.

The image sensor 38 may be a conventional image sensor that includes an array of image sensing elements arranged in rows and columns. For example, the image sensor 38 may be a CMOS active-pixel digital image sensor or any other image sensor in which image data may be selectively read. As a particular example, the image sensor 38 may be the MI-MV40 Digital Image Sensor available from Micron Technology, Inc., although any other suitable image sensor may be utilized without departing from the scope of the invention.

The camera 36 further includes timing circuitry 40 that controls an integration period of each of the image sensing elements. The integration period represents a time during which the particular image sensing element acquires charge as a function of light incident on the image sensing element. In accordance with the exemplary embodiment of the present invention, the timing circuitry 40 controls the integration period of the image sensing elements row-by-row. Specifically, the timing circuitry 40 selectively provides a row select/reset control signal to each row the image sensing elements within the image sensor 38. The integration period of a selected row of image sensing elements is defined by the time period between the when the row was last reset (reset) and the when the image data is read from the row (row select).

Consequently, the timing circuitry 40 is able to define the integration period of each of the rows of image sensing elements within the image sensor 38 by controlling the timing of the row select/reset control signal provided to the respective rows. The desired integration periods of each of the respective rows is determined by an image processor 42 included in the camera 36. More specifically, in addition to conventional processing of the image data, the image processor 42 includes gray filter circuitry 44. The gray filter circuitry 44 is operatively coupled to the timing circuitry 40 and serves to adjust the integration period of image sensing elements above a horizon defined within the field of view of the lens 22 relative to the integration period of image sensing elements below the horizon. As is explained in more detail below, the horizon may be detected within the field of view according to any of a variety of techniques. Such techniques are represented generally by horizon detection circuitry 46 included within the image processor 42.

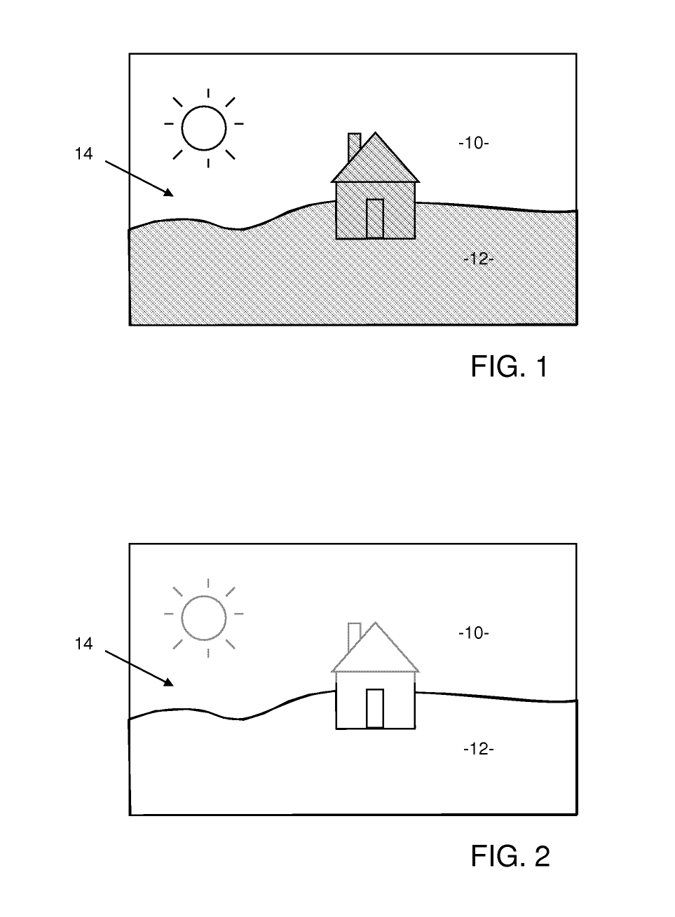

When a user takes a picture using the camera 36, the user will typically depress a shutter button (e.g., 24). At such time, the lens 22 focuses its field of view onto the image sensor 38. Referring briefly to FIG. 7, the timing circuitry 40 will proceed to provide row select/reset control signals to the respective rows of image sensing elements within the image sensor 38 in order to read out the image data making up the picture which is taken. In the exemplary embodiment, the timing circuitry 40 provides the row select/reset control signals in sequence to rows 1 thru N of the image sensor 38. Row 1 corresponds to the uppermost row in the field of view imaged onto the image sensor 38, and hence the uppermost portion of the sky 10 above a horizon 14 (see, FIGS. 1 and 2). Row N corresponds to the lowermost row in the field of view, and hence the bottommost portion of the 12 below the horizon 14. The timing circuitry 40 provides the timing of the row select/reset control signal such that the integration period of the rows of image sensing element above the horizon 14 is adjusted so as to be shorter than the integration period of the rows of image sensing elements below the horizon 14. Consequently, the camera 36 may compensate for limitations in the dynamic range of the camera, specifically in the case of landscape photography, by adjusting the integration period of the respective image sensing elements.

The image sensor 38 includes analog to digital converters (ADCs) 48 and 50 which convert the output of the respective image sensing elements to digital image data that is provided to the image processor 42. The image processor 42 then performs any additional image processing that may be desired, and outputs the data as photo image data to the controller 30 for use in accordance with the conventional camera functions 34 (e.g., such as viewing, labeling and/or sharing of photos, etc.).

It will be appreciated that the image processor 42 may be a separate dedicated processor, or may merely be incorporated within the controller 30. Furthermore, it will be appreciated that the timing circuitry 40, gray filter circuitry 44 and/or horizon detection circuitry 46 may be implemented via discrete circuitry, software and/or a combination thereof.

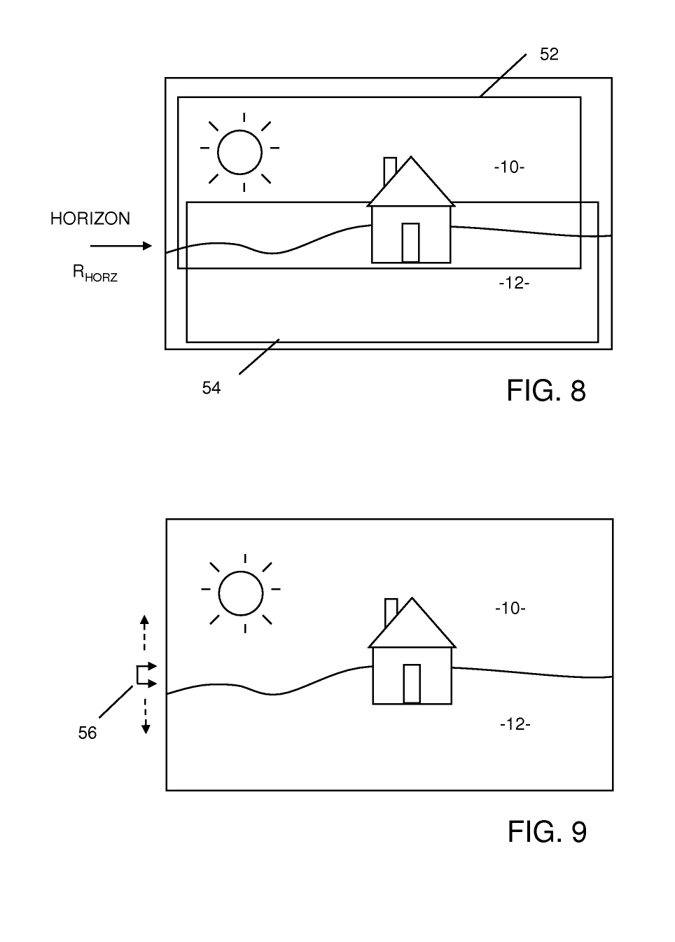

Referring now to FIG. 8, the operation of the horizontal detection circuitry 46 is illustrated in accordance with an exemplary embodiment of the invention. In this embodiment, when a user depresses the shutter button (e.g., 24) the camera 36 initially captures a first image for purposes of determining the location of the horizon 14 within the field of view. Thereafter, the camera 36 automatically captures a second image incorporating gray filtering by using different integration periods above and below the horizon 14 as determined via the first image. Upon acquiring the first image, the horizon detection circuitry 46 analyzes the image data row-by-row to determine whether a discrepancy in intensity distribution of at least a predefined degree exists between rows in an upper portion 52 and rows in a lower portion 54 of the field of view. In the event the horizon detection circuitry 46 identifies such a discrepancy, the horizon detection circuitry 46 identifies a row (or set of rows) R_{HORZ} within the field of view as constituting the horizon 14 for purposes of gray filtering. Thereafter, in the second image acquired automatically by the camera 36, the gray filter circuitry 44 determines the desired integration periods for the respective image sensing elements above and below the horizon 14 and provides such information to the timing circuitry 40. In this manner, the second image representing the photograph image desired by the user is obtained using the different integration periods above and below the horizon 14.

Since the camera 36 takes, in effect, two different images for each snapshot requested by the user, it is preferred that the image sensor 38 and/or image processor 42 have sufficient computing capacity/speed to process the snapshot without noticeable delay.

FIG. 9 illustrates an example of the operation of the horizontal detection circuitry 46 according to another embodiment. In this embodiment, the user may identify the horizon manually by virtue of moving a cursor 56 shown in a viewfinder of the camera 36. For example, the user, while viewing the image he or she wishes to take a picture of, may adjust the location of the cursor 56 up or down via one or more buttons (not shown) on the phone 10. The cursor 56 may be, for example, a pointer type icon that moves up and down along the left or right of the viewfinder image as shown in FIG. 9. As another example, the cursor 56 may be in the form of a horizontal line displayed across the image within the viewfinder. Various other type cursors may be used without departing from the scope of the invention as will be appreciated. The horizontal detection circuitry 46 then accepts as the horizon 14 the row or set of rows identified by the cursor 56 when the user then presses the shutter button in order to take the picture.

According to another embodiment, the horizontal detection circuitry 46 simply defines the horizon 14 at a predefined location within the field of view. For example, the horizon 14 may be predefined as the row or set of rows of image sensing elements at a location statistically identified as the location of the horizon in landscape photographs, e.g., approximately midway between the top and bottom of the field of view. In such an embodiment, it is preferred that the user be required to manually place the camera 36 in landscape photography mode. This may be done via a predefined selection switch (not shown) included in the phone 10 and/or as part of a menu selection.

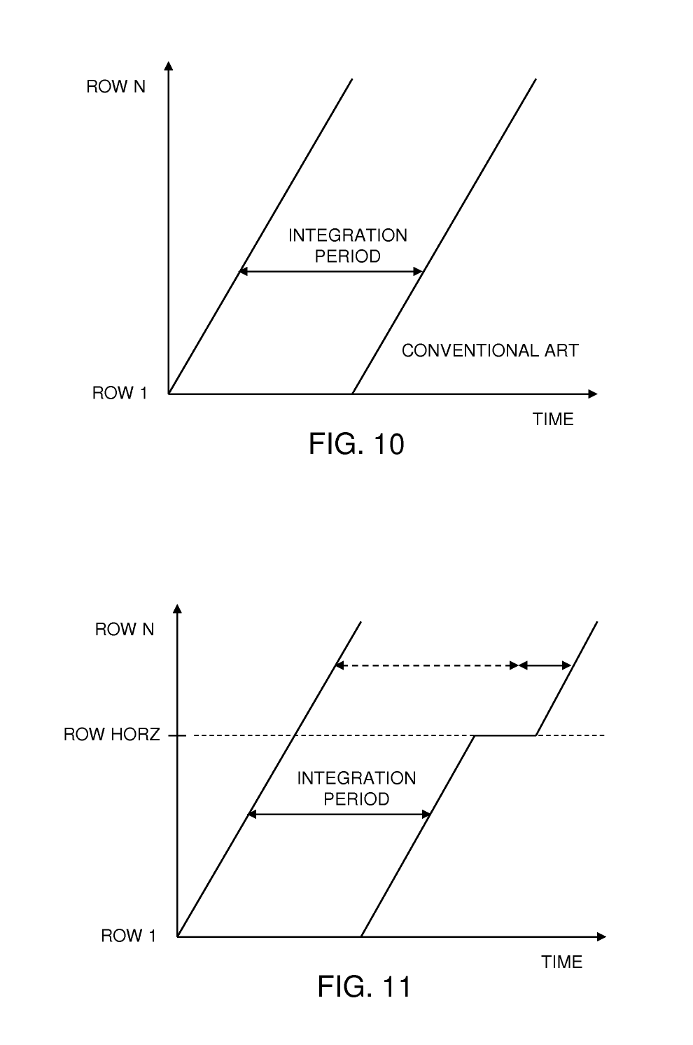

FIG. 10 illustrates the integration periods for the respective rows of image sensing elements in accordance with a conventional image sensor within a camera. As shown, as the data from each row 1 thru N is obtained in a given snapshot, the integration period for each row remains constant. Consequently, a conventional camera is subject to limitations in the dynamic range of the camera.

FIG. 11 illustrates a first example of the integration periods as defined by the gray filter circuitry 44 in accordance with the invention. The horizon 14 within the field of view is represented by row R_{HORZ}, with R_{HORZ} being determined by the horizon detecting circuitry 46 as discussed above. The gray filter circuitry 44 instructs the timing circuitry 40 to provide a first integration period for row 1 to row R_{HORZ} (corresponding to the sky 10), and second integration period longer than the first integration period for row R_{HORZ} to row N (corresponding to the land 12). Consequently, the gray filter circuitry 44 may select respective integration periods that maximize, yet do not exceed, the dynamic range of the camera 36.

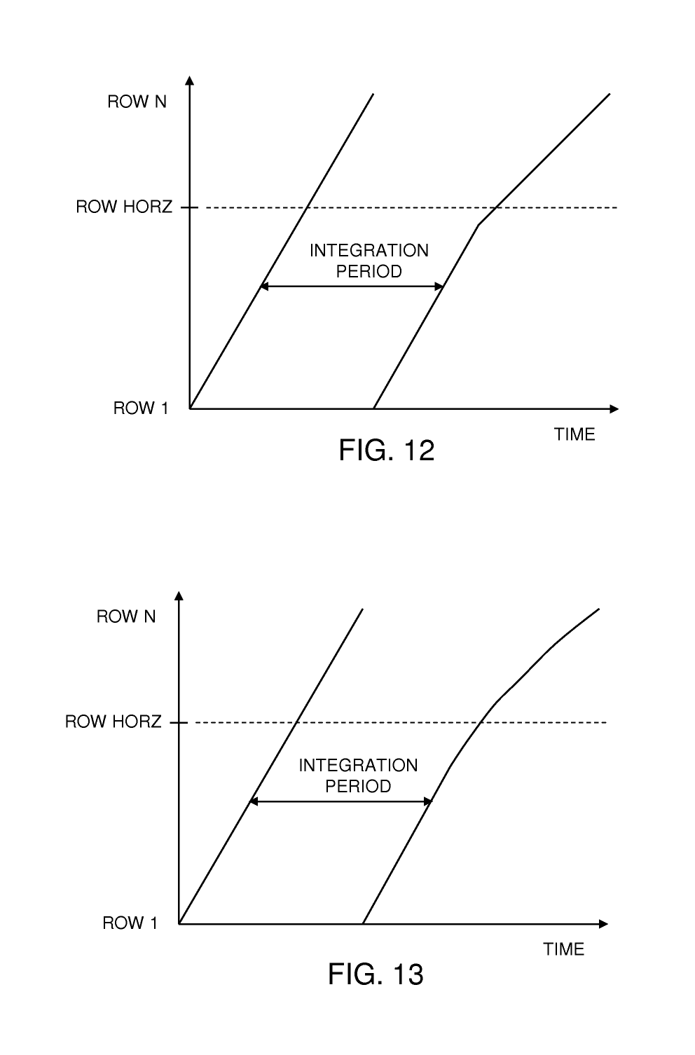

FIG. 12 illustrates another example of the integration periods defined by the gray filter circuitry 44. In this embodiment, the integration periods for rows above and below the horizon row R_{HORZ} change gradually so as to be less perceptible to the human eye. As is shown in FIG. 12, the gray filter circuitry 44 causes the integration period of the rows to begin to gradually increase just above R_{HORZ} on thru to row N. In this example, the integration period increases linearly. As is shown in FIG. 13, however, the change in integration period may be otherwise, such as non-linear.

Although not shown, the gray filter circuitry 44 may adjust the integration period of the respective rows of image sensing elements in a variety of other different manners without departing from the scope of the invention. For example, the integration period may be changed gradually throughout the field of view (i.e., from row 1 thru row N).

The relative change in integration periods implemented by the gray filter circuitry 44 above and below the horizon 14 may be predefined and/or dynamic according to the present invention. For example, the integration periods as reflected in the embodiments of FIGS. 11-13 described above may be implemented by way of a corresponding look-up table stored in memory. Alternatively, for example, the gray filter circuitry 44 may implement individual autoexposure loops in order to determine the relative integration periods dynamically. The gray filter circuitry 44 may execute a first autoexposure loop with respect to the image sensing elements above the defined horizon 14 in order to determine the integration period for the image sensing elements above the horizon. In addition, the gray filter circuitry 44 may execute a second autoexposure loop with respect to the image sensing elements below the defined horizon 14 to determine a corresponding integration period. As in the embodiments described above, the horizon 14 may be based on automated detection of the horizon, user movement of a cursor 56 to define the horizon, a fixed location within the field of view, etc.

Accordingly, the camera of the present invention avoids the above-described problems associated with landscape photography. The gray filter circuitry compensates for limitations in the dynamic range of the camera, specifically in the case of landscape photography, by adjusting the integration period of the respective image sensing elements. In the exemplary embodiment, the gray filter circuitry adjusts the integration periods such that the integration periods of the image sensing elements above the horizon are shorter than the integration periods of the image sensing elements below the horizon.

It will be appreciated, however, that the gray filter circuitry 44 in accordance with the present invention also can be used in the reverse direction to that described above. For example, situations may arise where the land 12 below the horizon 14 tends to be brighter than the sky 10 above the horizon (e.g., in the case of a snow-covered landscape). The gray filter circuitry 44 may be configured to detect such an inverse condition in brightness by performing an initial comparison (e.g., as part of automatic detection of the horizon as described above in relation to FIG. 8). The gray filter circuitry 44 than operates in a reverse direction to that described above in order that the integration period above the horizon is longer than the integration period below the horizon.

The term “camera” as referred to herein includes stand alone cameras as well as any other types of devices incorporating a camera. Such devices include, but are not limited to, pocket cameras, mobile phones, media players, pagers, electronic organizers, personal digital assistants (PDAs), smartphones, etc. The camera may be for taking still and/or moving pictures.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A camera, comprising:
an image sensor comprising an array of image sensing elements arranged in rows and columns;
a lens for imaging a field of view onto the image sensor;
timing circuitry that controls an integration period of each of the image sensing elements, the integration period representing a time during which the image sensing element acquires charge as a function of light incident on the image sensing element; and
gray filter circuitry, operatively coupled to the timing circuitry, for adjusting the integration period of image sensing elements above a horizon defined within the field of view relative to the integration period of image sensing elements below the horizon.

2. The camera of claim 1, wherein the integration period of each of the image sensing elements is defined by a period of time between the timing circuitry providing a reset control signal to the image sensing element and providing a read control signal to the image sensing element.

3. The camera of claim 1, wherein the horizon is generally defined by a fixed row or set of rows of the image sensing elements.

4. The camera of claim 1, wherein the horizon is generally defined by a row or set of rows of the image sensing elements, the particular row or set of rows being selectable.

5. The camera of claim 4, wherein the particular row or set of rows are selectable with a user input.

6. The camera of claim 4, further comprising horizon detection circuitry for automatically selecting the particular row or set of rows.

7. The camera of claim 6, wherein the horizon detection circuitry pre-analyzes relative amounts of light received by the image sensing elements in order to automatically select the particular row or set of rows.

8. The camera of claim 1, wherein the gray filter circuitry adjusts the integration period of the image sensing elements above the horizon so as to be shorter in time relative to the integration period of the image sensing elements below the horizon.

9. The camera of claim 1, wherein the integration periods of the image sensing elements above the horizon relative to the integration periods of the image sensing elements below the horizon change gradually.

10. The camera of claim 9, wherein the integration periods change linearly.

11. The camera of claim 9, wherein the integration periods change non-linearly.

12. The camera of claim 9, wherein the integration periods of the image sensing elements above the horizon relative to the integration periods of the image sensing elements below the horizon change on a row by row basis.

13. The camera of claim 1, wherein the integration periods of the image sensing elements above the horizon relative to the integration periods of the image sensing elements below the horizon change abruptly.

14. The camera of claim 1, wherein the gray filter circuitry is selectively enabled manually by a user input.

15. The camera of claim 1, wherein the gray filter circuitry is selectively enabled automatically.

16. The camera of claim 1, wherein the gray filter circuitry adjusts the integration period of the image sensing elements above the horizon so as to be longer in time relative to the integration period of the image sensing elements below the horizon.

17. The camera of claim 1, wherein the gray filter circuitry adjusts the relative integration periods using at least one of a look-up table and separate autoexposure loops corresponding to above and below the horizon.

18. A method for performing filtering in a camera, the camera including:
an image sensor comprising an array of image sensing elements arranged in rows and columns;
a lens for imaging a field of view onto the image sensor; and
timing circuitry that controls an integration period of each of the image sensing elements, the integration period representing a time during which the image sensing element acquires charge as a function of light incident on the image sensing element, the method comprising:
adjusting the integration period of image sensing elements above a horizon defined within the field of view relative to the integration period of image sensing elements below the horizon.

19. The method of claim 18, wherein the integration period of each of the image sensing elements is defined by a period of time between the timing circuitry providing a reset control signal to the image sensing element and providing a read control signal to the image sensing element.

20. The method of claim 18, comprising adjusting the integration periods in order that the adjusted integration periods of the image sensing elements above the horizon change gradually relative to the adjusted integration periods of the image sensing elements below the horizon.

21. The method of claim 18, comprising adjusting the integration periods of the image sensing elements above the horizon relative to the integration periods of the image sensing elements below the horizon change on a row by row basis.

22. The method of claim 18, comprising selectively defining the horizon automatically.
